(19) United States
(12) Patent Application Publication
(10) Pub. No.: US 2013/0161387 A1
(43) Pub. Date: Jun. 27, 2013

(54) METHOD AND APPARATUS FOR GENERATING PRINTED DOCUMENTS WITH INVISIBLE PRINTED CONDUCTIVE PATTERNS AS SECURITY FEATURES FOR DETECTING UNAUTHORIZED COPYING AND ALTERATIONS

(71) Applicant: Chao King, Fremont city, CA (US)

(72) Inventor: Chao King, Fremont city, CA (US)

(73) Assignee: KONICA MINOLTA LABORATORY U.S.A., INC., San Mateo, CA (US)

(21) Appl. No.: 13/333,192

(22) Filed: Dec. 21, 2011

(51) Int. Cl. G06F 7/02; B41J 11/44; B41F 33/00

(52) U.S. Cl. 235/431; 101/483; 400/76

(57) ABSTRACT

Methods of generating a secured printed document on paper or other medium by printing a security layer made of a transparent conductive material over the ink/toner layer that forms the visible content of the document. The security layer is printed using a transparent conductive material such as transparent conductive toner or ink and is invisible to human eyes. In one embodiment, the transparent conductive material contains a pattern that forms a radio frequency (RF) transponder circuit which has an RF antenna and a digital memory storing security data, which can be read out and used to authenticate the document. In another embodiment, the pattern forms a memory circuit without an RF antenna. In yet another embodiment, the transparent conductive material is patterned but does not form a functional circuit, and the electrical properties of the security layer such conductivity and/or capacitance are used to authenticate the document.

### BACKGROUND OF THE INVENTION

1. Field of the Invention

This invention relates to method and apparatus for generating printed documents, in particular, for generating printed documents with security features for detecting unauthorized copying and alterations.

2. Description of Related Art

It is a well known problem that documents printed on paper or other physical media are subject to duplication (copying) and potential alternation, and it can be difficult to guard and protect against unauthorized duplication and alternations. It is often difficult to verify whether the printed document is original or a copy as most of them are printed by printers and can be copied by copiers. It is often also difficult to check if the printed document has been altered or changed by a computer. In some applications, the paper of the original document is provided with built-in and often hidden security components so that a document without such security components can be discerned as a copy.

There are many known methods aimed at preventing un-authorized copying and alteration or making them more difficult to do. In one method, a barcode is printed on the document to store data that can be used to authenticate the document. This type of method adds extraneous visible content to the document. Other methods use invisible security features, but many such methods are difficult to implement in real-time and the cost of producing the original document can be high. In addition, some methods may make the secured documents difficult to handle as regular paper documents because the processing methods change the flexibility and weight of the paper.

### SUMMARY

The present invention is directed to a method and apparatus of generating printed documents with security features for detecting unauthorized copying and alterations.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method for producing a secured document, which includes: printing a visible content of the document on a medium; and printing a security layer over the visible content on the medium, the security layer comprising a layer of patterned transparent conductive material.

In one embodiment, the patterned transparent conductive material forms a memory circuit storing a security data. The step of printing the security layer may include: obtaining image data representing the visible content of the document; processing the image data to generate the security data; generating a memory circuit pattern based on the security data; and printing the memory circuit pattern using the transparent conductive material.

The step of printing the security layer may alternatively include: obtaining a document ID corresponding to the document as the security data; generating a memory circuit pattern based on the security data; and printing the memory circuit pattern using a transparent conductive material.

In another embodiment, the method further includes: measuring electrical properties of the printed security layer to obtain reference electrical property values; and performing one of the following steps: storing the reference electrical property values and a document ID in a storage device; printing a barcode on the medium which encodes the reference electrical property values, or printing a memory circuit pattern storing the reference electrical property values using the transparent conductive material. In another aspect, the present invention provides a method for authenticating a target printed document having a security layer printed over a visible content, the security layer comprising a layer of patterned transparent conductive material forming a memory circuit storing a security data, the method including: (a) scanning the document to generate a target image representing the visible content; (b) transmitting a probe signal to the memory circuit printed on the document and receiving any response from the memory circuit; (c) if no response is received, determining that the document is not authentic; and (d) if a response is received, (d1) obtaining the security data from the RF response; and (d2) determining whether the target document is authentic based on the target image and the security data.

In one embodiment, the security data stored in the memory circuit has been generated by processing an original image of the document using a predetermined algorithm, and wherein step (d2) includes: processing the target image generated in step (a) using the predetermined algorithm to generate target security data; and comparing the target security data and the security data obtained in step (d1) to determine whether they match each other.

In another embodiment, the security data stored in the memory circuit contains a document ID, and wherein step (d2) includes: obtaining the document ID from the security data; retrieving archived data from a storage device using the document ID, the archived data being descriptive of an original image of the document; and comparing the target image and archived data to determine whether the original image and the target image match each other.

In another aspect, the present invention provides a method for authenticating a target printed document having a security layer printed over a visible content, the security layer comprising a layer of patterned transparent conductive material, the method including: measuring electrical properties of the printed security layer; and obtaining reference values of the electrical properties, including obtaining the reference values from a barcode printed on the target document or retrieving the reference values from a storage device using a document ID obtained from the target document; and comparing the measured values of the electrical properties with the reference values to determine whether the target document is authentic.

In another aspect, the present invention provides printing system which includes: a first print engine for printing a visible content on a medium; a second print engine for printing a layer of patterned transparent conductive material on the medium to form a security layer; and a control section coupled to the first and second print engines, comprising one or more processors and memories having a computer readable program code embedded therein, the computer readable program code configured to cause the control section to execute a printing process including: controlling the first print engine to print a visible content of the document on a medium; obtaining image data representing the visible content of the document; processing the image data to generate a security data; generating a circuit pattern based on the security data, the circuit pattern including a memory circuit storing the security data; and controlling the second print engine to print the circuit pattern over the visible content using the transparent conductive material.

In another aspect, the present invention provides a system for authenticating a target printed document having a security layer printed over a visible content, the security layer comprising a layer of patterned transparent conductive material, the system including: a measurement device for measuring electrical properties of the printed security layer; a processing section coupled to the measurement device, comprising one or more processors and memories having a computer readable program code embedded therein, the computer readable program code configured to cause the processing section to execute an authentication process comprising: obtaining reference values of the electrical properties; and comparing the measured values of the electrical properties with the reference values to determine whether the target document is authentic.

It is to be understood that both the foregoing general description and the following detailed description are exemplary and explanatory and are intended to provide further explanation of the invention as claimed.

### BRIEF DESCRIPTION OF THE DRAWINGS

FIG. 1 illustrates an exemplary printed document carrying a security layer of patterned conductive material according to embodiments of the present invention.

FIG. 2 schematically illustrates a printing system for generating a printed document carrying the security layer according to an embodiment of the present invention.

FIG. 3 schematically illustrates a processing system for processing a target printed document to determine whether it is authentic according to an embodiment of the present invention.

FIG. 4 schematically illustrates an overall system in which embodiments of the present invention may be implemented.

FIGS. 5 and 6 schematically illustrate a method for generating a secured document carrying a security layer containing an RF transponder circuit, and for authenticating such a printed document, respectively, according to an embodiment of the present invention.

FIGS. 7 and 8 schematically illustrate a method for generating a secured document carrying a security layer containing an RF transponder circuit, and for authenticating such a printed document, respectively, according to another embodiment of the present invention.

FIGS. 9 and 10 schematically illustrate a method for generating a secured document carrying a layer of transparent conductive material, and for authenticating such a printed document, respectively, according to an alternative embodiment of the present invention.

### DETAILED DESCRIPTION OF PREFERRED EMBODIMENTS

Embodiments of the present invention provide methods of generating a secured printed document on paper or other medium, by printing a security layer made of a transparent conductive material on top of the original printed document, i.e., over the ink or toner layer that forms the visible content of the document. The security layer is printed using a transparent conductive material such as transparent conductive toner or ink and is invisible to human eyes. In a first group of embodiments, the transparent conductive material forms a pattern of a radio frequency (RF) transponder circuit which can be read by a contactless RF reader. In a second group of embodiments, the transparent conductive material forms a pattern of a memory circuit which can be read by a contact type reader. In a third group of embodiments, the transparent conductive material is patterned but does not form a functional circuit, and its electrical properties can be measured with a contact type measuring device.

In the first group of embodiments, the patterned transparent conductive layer forms a printed circuit which acts as both a digital memory and a radio frequency antenna electrically coupled to each other. The circuit can be activated by a radio frequency signal from a radio frequency reader, and respond by returning a stream of data based on the printed pattern. This way, data stored in the digital memory of the printed circuit, referred to herein as security data, can be read by an RF signal processing reader for purpose of authentication.

In one embodiment, the security data stored in the printed circuit correspond to the visible content of the printed document and can be processed by a computer for authentication (verification) purposes. Such data may be generated, at the time of printing, from the image data representing the visible content of the document. For example, the security data may be a hash code generated from the bitmap image of the visible content. As another example, the security data may be a compressed image of the document (e.g. a JPEG image). In another embodiment, the stored security data includes a document ID which can be used to retrieve archived data for purpose of authentication.

In the second group of embodiments, the transparent conductive layer forms a memory circuit pattern, but not a radio frequency antenna pattern. The memory circuit stores security data such as a hash code or a document ID similar to those in the first group of embodiments.

For the third group of alternative embodiments, the transparent conductive layer forms a conductive pattern, and electrical properties such as resistance, capacitance or inductance of the security layer may be measured by a suitable detector, for purpose of authentication.

Because the security layer printed over the document is transparent, a conventional copier cannot read its pattern to reproduce it during copying. Conventional copiers or printers also do not have the ability to print transparent conductive ink or toner to duplicate the patterned conductive material on a copy. Thus, if a document carrying the security layer is reproduced using a conventional copier, the resulting copy will not carry a patterned conductive material. Therefore, using a suitable reader or other detector, it is possible to determine whether a target printed document is an original printed document or a copy produced by a copier, as will be described in more detail later.

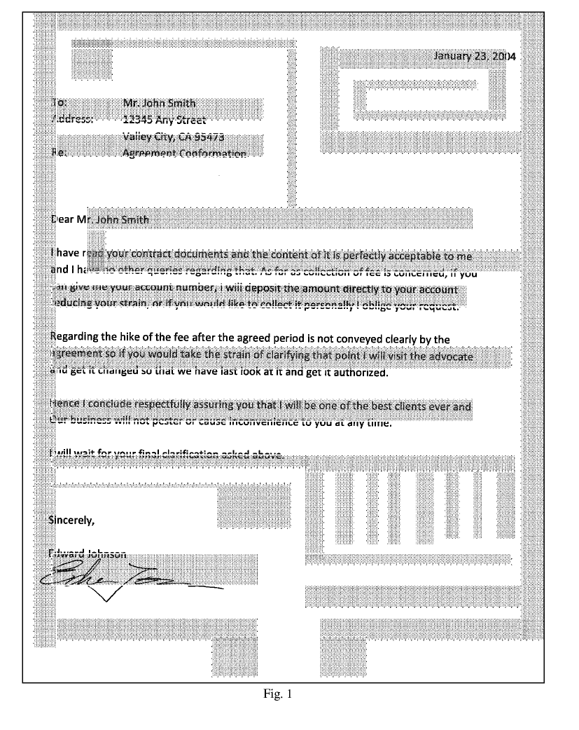

FIG. 1 illustrates an exemplary printed document carrying a security layer of patterned circuit pattern, which is schematically indicated by the dotted pattern. The pattern in this example is arbitrary and not an actual functional pattern. It should be noted that in the actual document the security layer is not visible to human eyes, and the circuit pattern is made visibly in this figure for purpose of illustration only.

In the example illustrated in FIG. 1, the patterned RF material extends substantially over the entire area of the printed document. Alternatively, it may only extend over a part of the printed document.

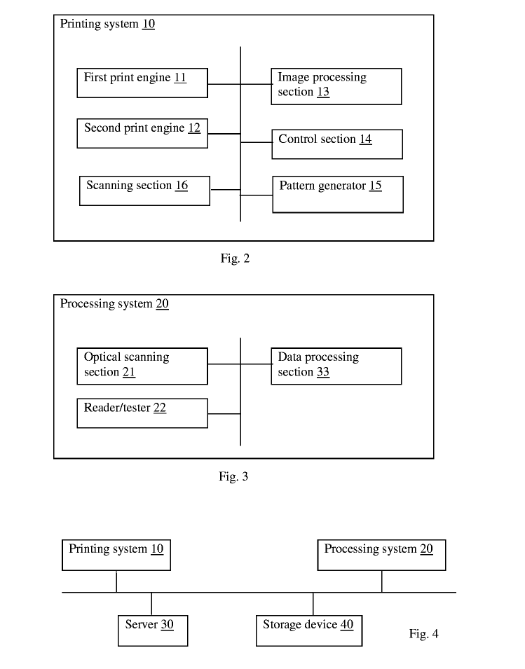

FIG. 2 schematically illustrates a printing system that may be used to generate a printed document carrying the security layer. The printing system 10 includes first and second printing sections (also referred to as print engines) 11 and 12, for printing the visible content of the printed document using regular ink or toner, and printing the invisible security layer using transparent conductive ink or toner, respectively. The system 10 also includes an image processing section 13 for performing functions such as raster image processing (RIP), etc.; a control section 14 for controlling the print engines and other components of the printing system as well as performing data processing functions such as generating the security data, etc. as will be described in more detail later; and a pattern generator 15. The pattern generator 15 generates the RF circuit pattern or memory circuit pattern based on the security data for the first and second groups of embodiments, or generates the conductive pattern for the third group of embodiments. The image processing section 13, the control section 14, and the pattern generator 15 may be implemented by one or more processors executing program code stored in memories, or other suitable electronic circuitry. The above mentioned components are connected to each other for example by a bus or other wired or wireless communication link. Other components of the printing system, such as an I/O section, etc., are not illustrated.

As described earlier, the invisible security layer is printed over the normal ink/toner layer that forms the visible content of the document. Thus, the printing process is carried out in two steps, the first to print the visible content, and the second to print the invisible security layer. In one embodiment, the first and second printing sections 11, 12 are physically located within one printer unit, so that the printer can perform both printing steps. A mechanical transport system may be provided so that the medium such as paper is automatically transported between the first and second print engines without operator intervention. In an alternative embodiment, the first and second printing sections 11, 12 are located in separate physical units, in which case an operator may be required to transport the medium from the location of the first printing section after the first printing step to the location of the second printing section.

More generally, the various components of the printing system 10 may be distributed in various physical units as desired. For example, the pattern generator 15 and the portion of the control section 14 that generates the security data may be located on a separate computer connected to the unit(s) that contains the print engines.

In a preferred embodiment, the printing system 10 also includes an optical scanning section 16. Suitable transport mechanisms may be provided to transport the medium among the scanning section 16 and the first and second print engines 11 and 12. Using such a printing system, an existing printed document (unsecured) may be scanned by the scanning section 16 to generate a document image, from which the security data is generated. Then, the printing system prints the document image on a medium using the first print engine 11 and prints the security layer using the second print engine 12 to generate a printed document carrying the security layer. This way, a secured printed document can be generated using an existing unsecured printed document. Alternatively, the printing system 10 may print the security layer directly over the existing printed document, whereby a security layer is added to the existing unsecured document to generate a secured document. In the latter case, the first print engine 11 is not necessary and may be omitted from the printing system 10.

Another function of the scanning section 16 is to scan the document that has been printed with the visible content by the first print engine but before the security layer is printed, as will described in more detail later.

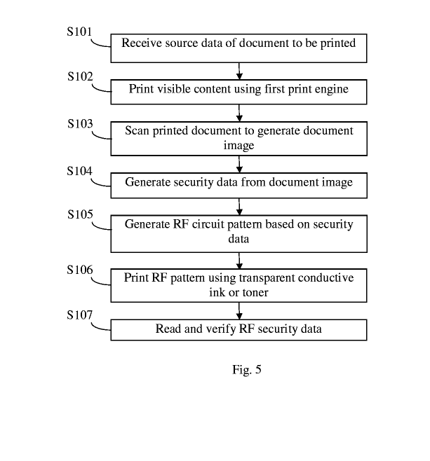

FIG. 3 schematically illustrates a processing system 20 which may be used to read and process a target printed document to determine whether it is an original document. The processing system 20 includes an optical scanning section 21 for scanning the visible content of the target document, and a reader/tester 22 for reading the security data stored in the printed circuit of the security layer or measuring the electrical properties of the security layer. For the first group of embodiment, the reader 22 may be a contactless RF reader, which transmits an RF probe signal to the printed RF circuit on a secured document, and receives the RF signal returned from the RF circuit. For the second group of embodiments, the reader may be a contact type signal processing reader described in more detail later. For the third group of embodiments, the tester may be a contact type detector such as an LCR ((Inductance (L), Capacitance (C), and Resistance (R)) tester described in more detail later. The processing system 20 further includes a data processing section 23 for processing the security data and the scanned image to determine whether the target document is authentic, as well as performing various other functions, as will be described in more detail later. The data processing section 23 may be implemented by one or more processors executing program code stored in memories, or other suitable electronic circuitry. The above mentioned components are connected to each other for example by a bus or other wired or wireless communication link. Other components of the printing system, such as an I/O section, etc., are not illustrated. The various components of the processing system 20 may be distributed in various physical units as desired.

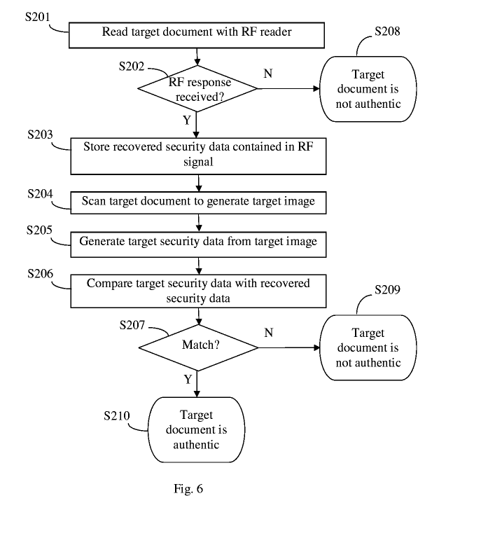

FIG. 4 schematically illustrates an overall system in which embodiments of the present invention may be implemented. The system includes the printing system 10, the processing system 20, one or more computers 30 (e.g. servers or client computers), and storage devices 40, connected via a network or other communication links. It should be noted that the printing system 10 and the processing system 20 are not required to be connected to the same network; they may be separately connected to respective servers which in turn are connected to the storage device, or not connected to any network at all. In particular, the printing system that prints a secured document and the processing system that reads a target document are not required to be at the same location or belong to the same organization.

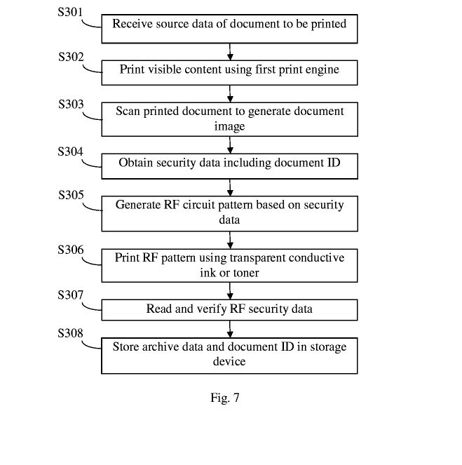

FIG. 5 schematically illustrates a method for generating a secured document carrying a security layer containing an RF transponder circuit using the printing system 10.

First, source data is received which represent the document to be printed (step S101). The source data is in electronic form and may be of any suitable format, such as PDF, JPG, text format, printed language such as PDL, etc. Based on the source data, a document is printed using the first print engine 11 on a medium (e.g. paper) (step S102). The document printed by step S102 carries the visible content of the document. This step includes any necessary data processing by the image processing section 13 and the control section 14.

Then, the printed document is scanned back using the scanning section 16 to generate a document image, preferably a bitmap image (step S103). The document image is processed by the control section 14 to generate security data (step S104). In a preferred embodiment, the security data includes a hash code generated from the binary document image. The security data may be encrypted and/or compressed to reduce the data size. Any suitable hash algorithm, encryption algorithm and compression algorithm may be used. Then, the pattern generator 15 generates an RF circuit pattern, which includes a memory circuit pattern based on the security data and an RF antenna pattern (the antenna pattern may be pre-stored in the printer or another processing system) (step S105). The second print engine 12 prints the RF circuit pattern, using transparent conductive ink or toner, on the medium over the visible content that was printed by the first print engine (step S106). The printed RF circuit pattern including the antenna pattern and the memory circuit pattern constitutes the security layer.

Optionally, the finished document may be read by an RF reader to verify that the security layer has been correctly printed and the security data is intact (step S107).

FIG. 6 schematically illustrates a method for authenticating a target printed document using the processing system 20. The target document is purported to have been printed using the process shown in FIG. 5.

First, the target document is read with the reader 22 such as an RF reader (step S201). If the document contains a security layer, the RF signal transmitted by the RF reader will activate the printed circuit pattern of the security layer, which will respond by transmitting the data stored in the memory circuit of the RF circuit pattern. If the RF reader does not receive a response from the target document or if the response is meaningless (“N” in step S202), it is determined that the target document is not original (e.g., it is copied or otherwise tampered with) (step S208). A response may be meaningless if, for example, a certain data format is expected but the received signal does not satisfy the format. If meaningful RF signal is received (“Y” in step S202), the security data contained in the RF signal is extracted and stored as recovered security data (step S203). If the security data has been encrypted during the printing process, it is decrypted in this step.

Then, the target document is scanned with the optical scanning section 21 to generate a target image (step S204). The target image is preferably a bitmap image. The target image is then processed, using the same algorithms as step S104 during the printing process, to generate target security data (step S205). The target security data is compared with the stored recovered security data (step S206). If they do not match (“N” in step S207), it is determined that the target document is not original (step S209). If they match (“Y” in step S207), it is determined that the target document is authentic (step S210).

In the embodiments shown in FIGS. 5 and 6, the authentication (i.e. determining whether the target document is an original document) is carried out based solely on the target document itself, without referring to any data not contained in the target document. In such a method, the document is referred to as self-authenticating. To implement a self-authenticating system, the printing system 10 and the processing system 20 are not required to be able to access a common storage device. In the preferred embodiment, the security data stored in the printed RF circuit is a hash code which is relatively short. Comparing the hash code recovered from the RF circuit with the hash code generated from the scanned target image can indicate whether the visible content of the document has been altered, but cannot indicate what the alterations are.

Alternatively, the security data may be a compressed image of the visible content, which can then be compared to the scanned target image to determine whether the images are the same. This alternative may be more difficult to implement because the data amount of the compressed image is relatively large and it may be difficult to print an RF pattern to store such a large amount of data. As another alternative, the security data may contain a compressed image of small but critical areas of the document, such as signatures, names, dates, numbers and other key contents.

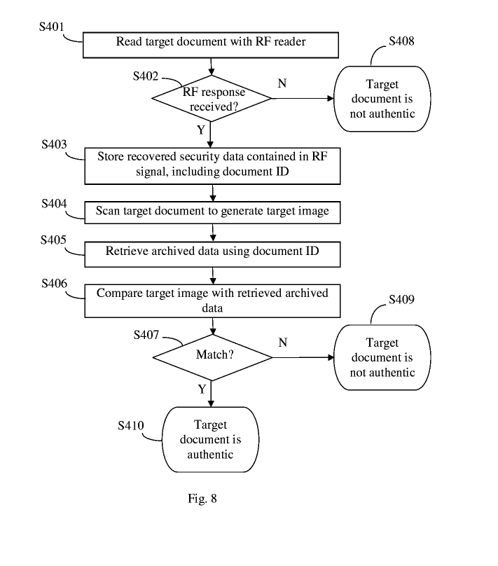

In lieu of a self-authenticating scheme, the RF pattern may be used in an authentication scheme in which archive data is stored in an external storage and used authenticate a target document. In such a method, archive data descriptive of the original document is stored in a storage device 40 during the printing process. Preferably, the archive data include the document image. It may also include desired document management information such as author, time of creation, etc. A document ID is assigned to each archived document for data retrieval later. The document ID is stored in the RF circuit pattern printed on the document, and is later used to retrieve the archived data to authenticate the document. Such an authentication scheme is shown in FIGS. 7 (printing process) and 8 (authentication process).

In the printing process shown in FIG. 7, steps S301 through S307 are generally the same as steps S101 through S107 of FIG. 5, except that in step S304, the document ID is used as a part of the security data. In step S308, the archive data with the document ID is stored in the storage device for later retrieval.

In the authentication process shown in FIG. 8, steps S401 through S410 are generally the same as steps S201 through S210 of FIG. 6, except that: in step S403, the recovered security data includes the document ID; in step S405, the document ID is used to retrieve archived data of the document from the storage device; and in step S406, the target image is compared with the archived data to determine whether the target document is authentic. For example, if the archived data includes the document image, the archived image and the target image may be compared in step S406. Because image comparison is used, this method can not only determine whether the target document is authentic, but also indicate what changes have been made.

Step S406 may be performed using a suitable image comparison algorithm. For example, image comparison may be performed on a pixel-by-pixel basis, or done by comparing various descriptive characteristics of the images. Alternatively, image comparison may be done manually by displaying the images to a user. Image comparison may be performed by a server connected to the processing system 20 as it tends to be computationally intensive.

The printing process shown in FIG. 5 starts with source data in electronic form. Alternatively, as mentioned earlier, a secured document may be generated from an existing hard copy document. In one scenario, the existing document is first scanned (not shown in FIG. 5) to generate the source data (e.g. a bitmap image), and then steps S102 through S106 are carried out. This results in a secured copy of the existing (unsecured) document, while the existing document can be preserved. In another scenario, the existing document is scanned in step S103 (steps S101 and S102 are bypassed), and steps S104 through S106 are carried out by printing the RF circuit pattern on the existing document itself. As a result, a security layer is added to the existing document over the existing visible content. The same modification can be made to the printing process shown in FIG. 7.

In the printing process shown in FIG. 5, the document image used to generate the security data (step S104) is obtained by scanning the printed document (step S103) after the visible content is printed by the first print engine (step S102). Alternatively, the document image may be generated directly from the source data. For example, if the source data is a bitmap image, it can be used directly. Otherwise, a bitmap image can be generated from the source data using available programs. However, scanning back the actual printed document (step S103) may offer the advantage that the scanned document image will be closer to the target image generated later in the authentication process (step S204). This is because the scanned image data will contain various effects due noise present in the printed document or other factors such as the color and reflectivity of the paper or other print medium. Thus, the hash code generated in the printing process (step S104) and the hash code generated in the authenticating process (step S205) will match better.

As mentioned earlier, in a second group of embodiments, the transparent conductive layer forms a memory circuit pattern for storing security data, but not a radio frequency antenna pattern. The memory circuit pattern preferably includes two or more contact pads. A contact type signal processing reader, equipped with contact terminals that can be placed in contact with the contact pads of the printed circuit, sends an electrical probe signal to the memory circuit. The memory circuit is designed so that it will respond to the probe signal by returning an electrical signal representing the stored digital data. The number of contact pads may be two for serial data transfer, or more for parallel data transfer. The contact pads are preferably located at predetermined locations of the printed document, and the contact type reader has contact terminations at corresponding locations to form electrical contact with the contact pads.

According to the second group of embodiments, a secured document carrying such a security layer may be generated using the printing system 10 in a process similar to that shown in FIG. 5 or FIG. 7, with the following modifications. In modified steps S105 and S305, a memory circuit pattern is generated based on the security data. Steps S106 and S306 are not changed but the pattern does not include an antenna pattern. In modified steps S107 and S307, the pattern is read by a contact type reader to verify the security data stored in the memory circuit.

According to the second group of embodiments, a target printed document may be read and authenticated using the processing system 20 in a process similar to that shown in FIG. 6 or FIG. 8, with the following modifications. In modified steps S201 and S401, the target document is read using a contact type reader rather than an RF reader. In modified steps S202 and S402, it is determined whether the security data can be read from the target document by the contact type reader. In steps S203 and S403, the security data is contained in the electrical signal transmitted by the memory circuit rather than the RF signal.

When the printed document is in circulation, the layer of transparent conductive material may be susceptible to damage either due to normal handling or due to deliberate tampering such as rubbing with an eraser. However, due to redundancy in the pattern (e.g., a conductive line may be damaged but not completely broken; some lines in the antenna pattern may be broken without losing the antenna function), the printed pattern can sustain certain amount of damage without losing its ability to correctly respond to the RF activation. Because the embodiments of FIGS. 5-8 and variation thereof rely on the content of the security data stored in the printed circuit to perform authentication, certain amount of damage or alteration of the printed circuit pattern will not change the authentication result.

This may be advantageous in practice (i.e. the security layer is not overly sensitive to normal handling), but may be disadvantageous in some situations. The line thickness of the circuit pattern may be designed based on practical considerations such as the amount of damage likely to occur due to normal handling of the printed document (which may, for example, depend on the property of medium the circuit is printed on). One way to mitigate the potential problem of insensitivity to deliberate alteration is to design the memory circuit pattern or the RF circuit pattern (in steps S105 and S305) such that the memory circuit pattern or the memory circuit part of the RF circuit pattern is located over important areas of the document, such as a signature. Because the memory part of the RF circuit pattern is more sensitive to physical tampering, this can better protect the important areas of the document. When such areas are tampered with, it will likely result in the memory circuit pattern being damaged leading to detectable errors in the response from the circuit.

As mentioned earlier, in a third group of embodiments, the electrical properties of the printed conductive materials are used as an indication of the integrity of the document. The electrical properties include conductivity (or impedance or resistance), capacitance and/or inductance. When the document is tampered with, for example, when an eraser or a sharp object is used to remove original printed content, the conductive materials over the content that is tampered with will be also removed or destroyed, so the electrical properties of the document will likely be changed. Resistance, capacitance and inductance may be measured using a contact type measurement device such as an LCR tester, which may be equipped with contact terminals arranged in a suitable pattern.

The conductive pattern printed over the document preferably includes contact pads for resistance, capacitance or inductance measurement using the LCR tester. The tester's terminals will contact the contact pads at pre-determined locations, and the resistance, capacitance and/or inductance of the printed conductive pattern can be measured. In a simple example, the conductive pattern is a set of parallel lines extending across the document with contact pads at both ends of each line. In another example, the conductive pattern includes one or more meandering lines with contact pads at both ends of each line. The track resistance R of such a line pattern is a function of the total printed circuit length L divided by the cross section of the pattern A: R=K*ρ*L/A, where K is a constant and ρ is the resistivity of the conductive material. A change in the width or thickness of the printed line pattern, or removal of segments of the lines, will result in a change of the measured resistivity.

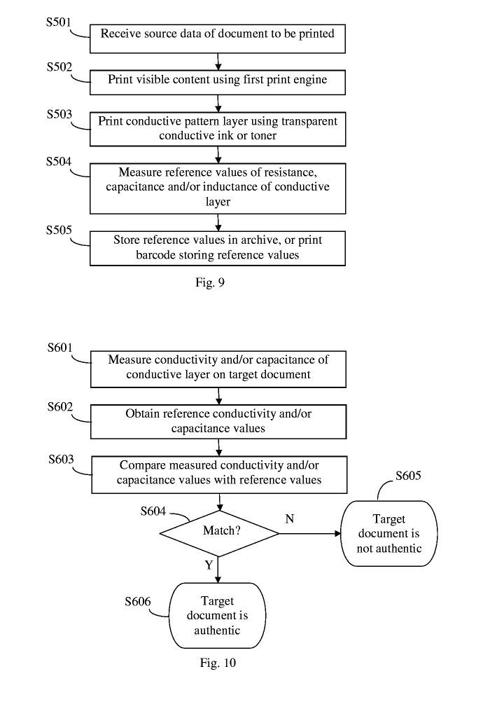

During the printing process according to the third group of embodiment, illustrated in FIG. 9, after the visible content and the conductive pattern layer are printed (steps S501 through S503), the conductivity and/or capacitance of the printed document are measured using the contact type measurement device (step S504). The measured values (reference values) are stored in a storage device as a part of the archived data (step S505). Alternatively, the reference values may be coded in a barcode and printed on the document itself (step S505, which is a third printing step using the first print engine). If the reference data is stored externally in an archive, a document ID is stored in the RF circuit (in step S503) or in a barcode printed on the document (in step S502).

During the authentication process, illustrated in FIG. 10, the conductivity and/or capacitance of the target document are measured using a contact type measurement device such as an LCR tester (step S601). The reference conductivity and/or capacitance values are obtained, e.g., read from the RF circuit or the barcode, or retrieved from the archive using the document ID read from the RF circuit or the barcode (step S602). The measure conductivity and/or capacitance values are compared to the reference values to determine whether the document had been tampered (steps S603 through S606).

When the electrical properties are used for document authentication, the printed conductive material may form a non-functional pattern, i.e., one that does not form an RF circuit or a memory circuit. In such cases, the electrical properties alone are used for document authentication. In alternative embodiments, both functional circuit patterns and non-functional patterns may be used. For example, a non-functional conductive pattern may be placed over an area of the document such as a signature area, and estimated or measured reference values of electrical properties of the non-functional pattern are stored in a memory circuit also printed on the document. This eliminates the need to print a barcode storing the reference values or to store the reference values in an archive. In other words, step S505 of FIG. 9 may be modified to printing a memory pattern storing the reference values. If the reference values are actually measured from the non-functional pattern after it is printed, a two-pass printing of the transparent conductive material may be required, once to print the non-functional circuit, the second to print the memory circuit storing the measured reference values. During authentication, in step S602 of FIG. 10, a reader is used to read the stored data from the printed circuit pattern. The other steps of FIG. 10 are unchanged.

As seen from the above descriptions, a common feature of the various methods according to various embodiments of the present invention is that a patterned transparent conductive layer is printed over the visible content of the document as a security layer. In the first and second groups of embodiments (FIGS. 5-8 and modified versions thereof), the patterned transparent conductive layer forms an RF transponder circuit or a memory circuit which stores security data to be used for document authentication. In the third group of embodiments (FIGS. 9-10), electrical properties of the transparent conductive layer are used to authenticate the document.

It will be apparent to those skilled in the art that various modification and variations can be made in the document authentication method and apparatus of the present invention without departing from the spirit or scope of the invention. Thus, it is intended that the present invention cover modifications and variations that come within the scope of the appended claims and their equivalents.

1. A method for producing a secured document, comprising:
printing a visible content of the document on a medium; and
printing a security layer over the visible content on the medium, the security layer comprising a layer of patterned transparent conductive material which forms a memory circuit storing a security data and a radio frequency (RF) antenna electrically coupled to the memory circuit, the RF antenna and the memory circuit forming an RF transponder circuit.

2. (canceled)

3. The method of claim 1, wherein the step of printing the security layer comprises:
obtaining image data representing the visible content of the document;
processing the image data to generate the security data;
generating a memory circuit pattern based on the security data; and
printing the memory circuit pattern using the transparent conductive material.

4. The method of claim 3, wherein the step of obtaining the image data includes scanning a printed document which has been generated by the step of printing the visible content.

5. The method of claim 1, wherein the step of printing the security layer comprises:
obtaining a document ID corresponding to the document as the security data;
generating a memory circuit pattern based on the security data; and
printing the memory circuit pattern using a transparent conductive material.

6. The method of claim 5, further comprising:
storing archive data descriptive of the document with the document ID in a storage device.

7. (canceled)

8. A method for producing a secured document, comprising:
printing a visible content of the document on a medium;
printing a security layer over the visible content on the medium, the security layer comprising a layer of patterned transparent conductive material;
measuring electrical properties of the printed security layer to obtain reference electrical property values; and
performing one of the following steps:
storing the reference electrical property values and a document ID in an external storage device;
printing a visible barcode on the medium which encodes the reference electrical property values; or
printing a memory circuit pattern storing the reference electrical property values using the transparent conductive material.

9. The method of claim 8, wherein the electrical properties include resistance, capacitance or inductance.

10. The method of claim 1, wherein the security layer is printed using transparent conductive toner or ink.

11. A method for authenticating a target printed document having a security layer printed over a visible content, the security layer comprising a layer of patterned transparent conductive material forming a memory circuit storing a security data and a radio frequency (RF) antenna electrically coupled to the memory circuit, the RF antenna and the memory circuit forming an RF transponder circuit, the method comprising:
(a) scanning the document to generate a target image representing the visible content;
(b) using a contactless RF reader, transmitting a probe signal to the RF transponder circuit printed on the document and receiving any response from the RF transponder circuit;
(c) if no response is received, determining that the document is not authentic; and
(d) if a response is received,
(d1) obtaining the security data from the response; and
(d2) determining whether the target document is authentic based on the target image and the security data.

12. The method of claim 11, wherein the security data stored in the memory circuit has been generated by processing an original image of the document using a predetermined algorithm, and wherein step (d2) comprises:
processing the target image generated in step (a) using the predetermined algorithm to generate target security data; and
comparing the target security data and the security data obtained in step (dl) to determine whether they match each other.

13. The method of claim 11, wherein the security data stored in the memory circuit contains a document ID, and wherein step (d2) comprises:
obtaining the document ID from the security data;
retrieving archived data from a storage device using the document ID, the archived data being descriptive of an original image of the document; and
comparing the target image and archived data to determine whether the original image and the target image match each other.

14.-15. (canceled)

16. A method for authenticating a target printed document having a security layer printed over a visible content, the security layer comprising a layer of patterned transparent conductive material, the method comprising:
measuring electrical properties of the printed security layer;
obtaining reference values of the electrical properties, including obtaining the reference values from a visible barcode printed on the target document or retrieving the reference values from an external storage device using a document ID obtained from the target document; and
comparing the measured values of the electrical properties with the reference values to determine whether the target document is authentic.

17. The method of claim 16, wherein the electrical properties include resistance, capacitance or inductance.

18. The method of claim 16, wherein printed security layer forms a pattern including a plurality of contact pads, and
wherein the measuring step is performed by a contact LCR ((Inductance (L), Capacitance (C), and Resistance (R)) tester which has a plurality of contact terminals for forming electrical contact with the contact pads of the security layer.

19. A printing system comprising:
a first print engine for printing a visible content on a medium;
a second print engine for printing a layer of patterned transparent conductive material on the medium to form a security layer; and
a control section coupled to the first and second print engines, comprising one or more processors and memories having a computer readable program code embedded therein, the computer readable program code configured to cause the control section to execute a printing process comprising:
controlling the first print engine to print a visible content of the document on a medium;
obtaining image data representing the visible content of the document;
generating a security data representative of the image data or a document ID;
generating a circuit pattern based on the security data, the circuit pattern including a memory circuit storing the security data and a radio frequency (RF) antenna electrically coupled to the memory circuit, the RF antenna and the memory circuit forming an RF transponder circuit; and
controlling the second print engine to print the circuit pattern over the visible content using the transparent conductive material.

20. (canceled)

21. A system for authenticating a target printed document having a security layer printed over a visible content, the security layer comprising a layer of patterned transparent conductive material forming a memory circuit storing a security data and a radio frequency (RF) antenna electrically coupled to the memory circuit, the RF antenna and the memory circuit forming an RF transponder circuit, the system comprising:
a scanning section for scanning the document to generate a target image representing the visible content;
a contactless RF reader for transmitting a probe signal to the RF transponder circuit printed on the document and receiving any response from the RF transponder circuit;
a processing section coupled to the scanning section and the reader, comprising one or more processors and memories having a computer readable program code embedded therein, the computer readable program code configured to cause the processing section to execute an authentication process comprising:
(a) if no response from the memory circuit is received by the reader, determining that the document is not authentic; and
(b) if a response is received,
(b1) obtaining the security data from the response; and
(b2) determining whether the target document is authentic based on the target image obtained by the scanning section and the security data.

22. The system of claim 21, wherein the security data stored in the memory circuit has been generated by processing an original image of the document using a predetermined algorithm, and wherein step (a2) comprises:
processing the target image using the predetermined algorithm to generate target security data; and
comparing the target security data and the security data obtained in step (b1) to determine whether they match each other.

23. The system of claim 21, wherein the security data stored in the memory circuit contains a document ID, and wherein step (a2) comprises:
obtaining the document ID from the security data;
retrieving archived data from a storage device using the document ID, the archived data being descriptive of an original image of the document; and
comparing the target image and archived data to determine whether the original image and the target image match each other.

24.-27. (canceled)
